(19) United States
(12) Patent Application Publication
(10) Pub. No.: US 2009/0046962 A1
(43) Pub. Date: Feb. 19, 2009

(54) MAIN BEARING SUPPORT STRUCTURE FOR AN INTERNAL COMBUSTION ENGINE

(75) Inventors: Scott M. Kociba, Clarkston, MI (US); Alan E. Rice, New Baltimore, MI (US); Greg Thurston, Clarkston, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 11/972,063

(22) Filed: Jan. 10, 2008

Related U.S. Application Data
(60) Provisional application No. 60/955,979, filed on Aug. 15, 2007.

(51) Int. Cl. F16C 9/02

(52) U.S. Cl. 384/294; 123/195 R

(57) ABSTRACT

A main bearing cap support structure is provided including a bulkhead and a main bearing cap removably mountable thereto by at least one threaded fastener. The threaded fastener includes a highly toleranced (i.e. controlled both dimensionally and geometrically) generally annular collar sufficiently configured to be received within a highly toleranced bore portion defined by the bulkhead and the main bearing cap such that the main bearing cap may be precisely aligned with the bulkhead.

### CROSS-REFERENCE TO RELATED APPLICATIONS

This application claims the benefit of U.S. Provisional Application 60/955,979, filed Aug. 15, 2007, which is hereby incorporated by reference in its entirety.

### TECHNICAL FIELD

The present invention relates to a main bearing support structure for aligning main bearing caps with respect to an engine block of an internal combustion engine.

### BACKGROUND OF THE INVENTION

Traditionally, crankshafts have been rotatably supported within an engine block of an internal combustion engine by a plurality of removable main bearing caps secured to the engine block. Each removable main bearing cap includes a semi-circular recess that cooperates with a semi-circular recess in the engine block to directly support, or indirectly support, through removable bearing shells or inserts, spaced journals of the crankshaft.

Historically, various forms of main bearing cap constructions have been proposed but for reasons of strength, cost, and ease of mass production, most main bearing caps have been formed by the methods of casting or forging iron or steel materials. The mating surfaces of these known main bearing caps and their respective engine block mounting locations are typically flat.

More recently, the main bearing caps have been formed integrally with the engine block and are then fractured or cracked to separate the main bearing caps therefrom. This fracturing process results in an uneven, but complementary, mating surface on each of the main bearing cap and engine block due to the grain of the metal forming the engine block and main bearing cap. This ensures that, upon reassembly, the main bearing cap will be perfectly positioned with respect to the engine block.

However, if both of the mating surfaces of the main bearing cap and the engine block are flat, minor misalignments can occur during assembly resulting in, insufficient crush of the bearing inserts, insufficient bearing contact, and/or damage to the mating components.

### SUMMARY OF THE INVENTION

A main bearing support structure is provided for an internal combustion engine having an engine block. The main bearing support structure includes a bulkhead formed on the engine block and a main bearing cap removably mounted to the bulkhead by at least one threaded fastener. The bulkhead and the main bearing cap cooperate to define at least one bore sufficiently configured to receive the at least one threaded fastener. The bore includes a first bore portion of a first predetermined diameter and a threaded portion. The bulkhead defines the threaded portion, while the main bearing cap and the bulkhead cooperate to form the first bore portion.

The at least one threaded fastener includes a shank portion and a threaded portion. The threaded portion of the at least one threaded fastener is engagable with the threaded portion of the bore. The shank portion includes a generally annular collar portion receivable within the first bore portion of the bore to align the main bearing cap with the bulkhead. The first predetermined diameter is highly tolerance, i.e. controlled both dimensionally and geometrically, and formed by precision machining, for example a reaming operation. The bore may further include a second bore portion of a second predetermined diameter. The second predetermined diameter is greater than the first predetermined diameter.

A method of aligning the main bearing support structure is also provided, which includes: providing the main bearing support structure; providing at least one bore through each of main bearing caps and extending into the bulkhead; providing a fastener for installation into each of the bores; and installing the fasteners into each of the bores, such that the annular collar of the fastener cooperates with the bore to precisely align each of the main bearing caps with the bulkhead.

The above features and advantages of the present invention are readily apparent from the following detailed description of the best modes for carrying out the invention when taken in connection with the accompanying drawings.

### BRIEF DESCRIPTION OF THE DRAWINGS

FIG. 1 is a cross sectional view of a portion of an internal combustion engine illustrating a main bearing support structure having a main bearing cap removably mounted to a bulkhead by threaded fasteners;

FIG. 2 is a cross sectional view of the portion highlighted by a phantom oval, indicated at 2 of FIG. 1, with the threaded fastener removed for clarity; and

FIG. 3 is a side view of the threaded fastener of FIG. 1.

### DESCRIPTION OF THE PREFERRED EMBODIMENTS

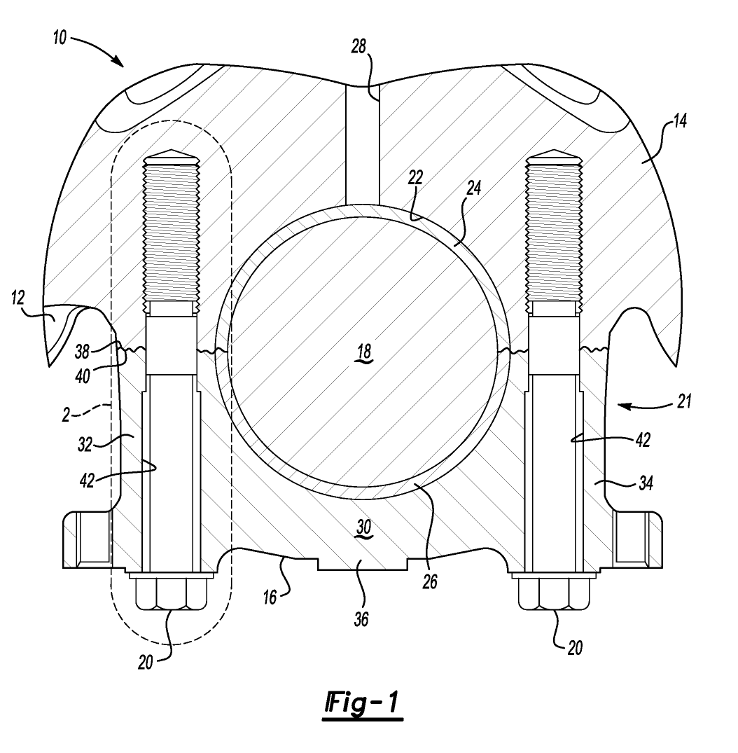

Referring to the drawings wherein like reference numbers correspond to like or similar components throughout the several figures, there is shown in FIG. 1 a portion of an internal combustion engine, generally indicated at 10. The internal combustion engine 10 includes an engine block 12 having a bulkhead 14 formed thereon. The bulkhead 14 cooperates with a main bearing cap 16 to rotatably support a crankshaft 18 within the engine block 12. The main bearing cap 16 is removably mountable to the bulkhead 14 by a plurality of threaded fasteners 20.

The bulkhead 14, main bearing cap 16, and the plurality of fasteners 20 form a main bearing support structure, generally indicated at 21. The main bearing cap 16 and the bulkhead 14 cooperate to define a generally cylindrical bore 22 within which first and second bearing shells or inserts 24 and 26, respectively, are retained.

The first and second bearing inserts 24 and 26 provide a bearing surface upon which the crankshaft 18 is rotatable. The bulkhead 14 defines a main bearing feed passage 28 operable to communicate pressurized oil to the interface between the crankshaft 18 and the first and second main bearing inserts 24 and 26 for lubrication thereof.

The main bearing cap 16 includes a main body 30. The main body 30 includes first and second leg portions 32 and 34, respectively, having a saddle portion 36 extending therebetween. The main bearing cap 16 is formed integrally with the bulkhead 14 during, for example, a casting process. Once cast, the main bearing cap 16 is separated from the bulkhead 14 through a fracturing or cracking operation. As a result, a mounting surface 38 of the main bearing cap 16 and a mounting surface 40 of the bulkhead 14 each have an irregular, but complementary, surface that is engagable to provide a measure of alignment between the main bearing cap 16 and the bulkhead 14.

The main bearing cap 16 and the bulkhead 14, of the illustrated example, are cast from compacted graphite iron such that the requisite fracture characteristics are provided. The main bearing cap 16 and the bulkhead 14 cooperate to define bores 42 sufficiently configured to receive the treaded fasteners 20 therein. However, it should be noted that manufacture of the main bearing cap 16 and the bulkhead 14 is not limited to cast compacted graphite, so long as the requisite fracture characteristics are maintained.

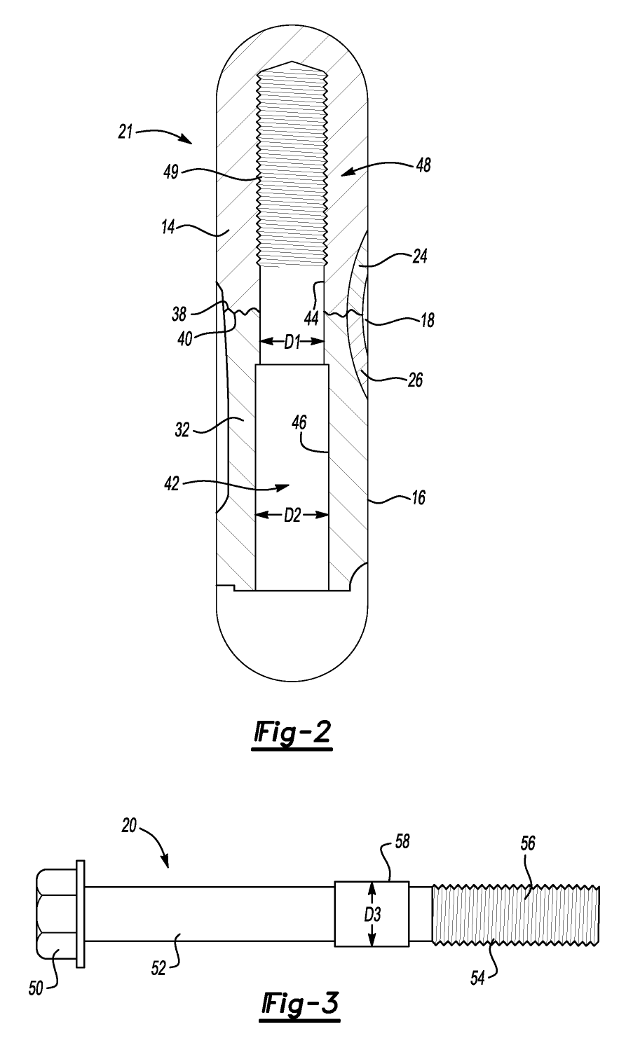

Referring now to FIG. 2 and with continued reference to FIG. 1, there is shown a portion of the bearing support structure 21, highlighted by phantom lines and indicated at 2, of FIG. 1. The fastener 20 has been removed in FIG. 2 for clarity and the structure of the fastener 20 will be discussed in greater detail hereinbelow with reference to FIG. 3.

The bore 42 has a first bore portion 44, second bore portion 46, and a threaded portion 48. The first bore portion 44 has a predetermined diameter D₁, while the second bore portion 46 has a predetermined diameter D₂. The predetermined diameter D₁ is smaller than the predetermined diameter D₂. The second bore portion 46 is defined by the main bearing cap 16, while the threaded portion 48 is defined by the bulkhead 14.

The threaded portion 48 has a plurality of threads 49 formed thereon of predetermined diameter and pitch. The main bearing cap 16 and the bulkhead 14 cooperate to define the first bore portion 44 of the bore 42. The first bore portion 44 is highly toleranced, i.e. controlled both dimensionally and geometrically, and formed by precision machining, such as a reaming operation.

Referring to FIG. 3 and with continued reference to FIGS. 1 and 2, there is shown the threaded fastener 20 of FIG. 1. The threaded fastener 20 includes a head portion 50, shank portion 52, and a threaded portion 54. The threaded portion 54 includes a plurality of threads 56 sufficiently configured to threadingly engage complementary threads 49 formed on the threaded portion 48 of the bore 42 to retain the threaded fastener 20 with respect to the bulkhead 14.

The head portion 50 of the threaded fastener 20 is operable to engage the main bearing cap 16 thereby retaining the main bearing cap 16 with respect to the bulkhead 14. The shank portion 52 includes a generally annular collar 58 formed thereon and having a predetermined diameter D₃, which is smaller than the predetermined diameter D₁ of the bore 42.

The annular collar 58 is configured to be received within the first bore portion 44 of the bore 42 and is operable to provide precise alignment between the main bearing cap 16 and the bulkhead 14. The predetermined diameter D₃ of the annular collar 58 is highly toleranced, i.e. controlled dimensionally and geometrically, and is formed by precision forming or precision machining, such as a grinding operation.

In one embodiment, the clearance between the annular collar 58 and the first bore portion 44 of the bore 42 is in the range of, but not limited to, 0.02 mm to 0.20 mm. The annular collar 58 and the first bore portion 44 of the bore 42 cooperate to reduce the likelihood of misalignment between the main bearing cap 16 and the bulkhead 14 during assembly of the internal combustion engine 10. As such, engine damage as a result of misalignment of the main bearing cap 16 may be substantially reduced.

A method of aligning the main bearing support structure 21 is also provided, which includes: providing the main bearing support structure 21; providing at least one bore 42 through each of main bearing caps 16 and extending into the bulkhead 14; providing a fastener 20 for installation into each of the bores 42; and installing the fasteners 20 into each of the bores 42, such that the annular collar 58 of the fastener 20 cooperates with the bore 42 to precisely align each of the main bearing caps 16 with the bulkhead 14.

In the example method, the main bearing support structure 21 includes the bulkhead 14, the main bearing caps 16 and the plurality of fasteners 20. The bulkhead 14 and the main bearing caps 16 are formed integrally by a casting process. The main bearing caps 16 are subsequently separated from the bulkhead 14 through a fracturing or cracking operation, such that the mounting surface 38 of the main bearing cap 16 and the mounting surface of the bulkhead 14 each have an irregular, but complementary surface that is engagable to provide a measure of alignment between the main bearing cap 16 and the bulkhead upon re-assembly.

The main bearing structure includes bores 42, which extend through the main bearing cap 16 and into the bulkhead 14. Each of the bores 42 includes a first bore portion 44, a second bore portion 46 and a threaded portion 48. The first bore portion 44 of each of the bores 42 has a diameter D₁ which is smaller than a diameter D₂ of the second bore portion 46. The first bore portion 44 is highly toleranced, i.e. both dimensionally and geometrically controlled.

Each of the plurality of fasteners 20 includes a head portion 50, a shank portion 52 and a threaded portion 54. The threaded portion 54, which includes a plurality of threads 56 sufficiently configured to threadingly engage complementary threads 49 formed on the threaded portion 48 of each of the bores 42.

The shank portion 52 of each of the plurality of fasteners includes an annular collar 58 having a diameter D₃, which is smaller than the diameter D₁. The annular collar 58 is configured to be received within the first bore portion of the bore 42 and is operable to provide precise alignment between the main bearing cap 16 and the bulkhead 14.

While the bore 42 described hereinabove has first and second bore portions 44 and 46 forming a generally stepped bore, those skilled in the art will recognize that the bore 42 may be formed having only the first bore portion 44 such that the entirety of the bore 42, apart from the threaded portion 48, is a highly toleranced, i.e. controlled dimensionally and geometrically, bore of the first predetermined diameter D₁.

Further, while the best modes for carrying out the invention have been described in detail, those familiar with the art to which this invention relates will recognize various alternative designs and embodiments for practicing the invention within the scope of the appended claims.

1. A main bearing support structure for an internal combustion engine having an engine block, the main bearing support structure comprising:
a bulkhead formed on the engine block;
a main bearing cap removably mounted to the bulkhead by at least one threaded fastener;
wherein the bulkhead and the main bearing cap cooperate to define at least one bore sufficiently configured to receive the at least one threaded fastener;
wherein the bore includes a first bore portion of a first predetermined diameter and a threaded portion;
wherein the bulkhead defines the threaded portion, and the main bearing cap and the bulkhead cooperate to form the first bore portion;
wherein the at least one threaded fastener includes a shank portion and a threaded portion, the threaded portion of the at least one threaded fastener being engagable with the threaded portion of the bore; and
wherein the shank portion includes a generally annular collar portion dimensioned to be received within the first bore portion of the bore to align the main bearing cap with the bulkhead.

2. The main bearing support structure as recited in claim 1, further comprising:
a second bore portion of a second predetermined diameter;
wherein the second predetermined diameter is greater than the first predetermined diameter; and
wherein the main bearing cap defines the first bore portion.

3. The main bearing support structure as recited in claim 1, wherein the first bore portion of the bore is formed by reaming.

4. The main bearing support structure as recited in claim 1, wherein the generally annular collar portion of the shank portion is formed by one of precision forming and grinding.

5. The main bearing support structure as recited in claim 1, wherein the main bearing cap is formed integrally with the bulkhead and is subsequently separated from the bulkhead by a fracturing process such that a fracture line is defined by a mounting surface on the bulkhead and a mounting surface on the main bearing cap, the fracture line intersecting the first bore portion.

6. The main bearing support structure as recited in claim 1, wherein the clearance between the generally annular collar and the first bore portion is between approximately 0.02 mm and 0.20 mm.

7. The main bearing support structure as recited in claim 1, wherein the bulkhead and the main bearing cap are formed from compacted graphite iron.

8. An internal combustion engine including a main bearing support structure, the main bearing support structure comprising:
a main bearing cap removably mounted to a bulkhead by at least one threaded fastener;
wherein the bulkhead and the main bearing cap cooperate to define at least one bore sufficiently configured to receive the at least one threaded fastener;
wherein the bore includes a first bore portion of a first predetermined diameter and a threaded portion;
wherein the bulkhead defines the threaded portion, and the main bearing cap and the bulkhead cooperate to form the first bore portion;
wherein the at least one threaded fastener includes a shank portion and a threaded portion, the threaded portion of the at least one threaded fastener being engagable with the threaded portion of the bore; and
wherein the shank portion includes a generally annular collar portion dimensioned to be received within the first bore portion of the bore to align the main bearing cap with the bulkhead.

9. The internal combustion engine as recited in claim 8, the main bearing support structure further comprising:
a second bore portion of a second predetermined diameter;
wherein the second predetermined diameter is greater than the first predetermined diameter; and
wherein the main bearing cap defines the first bore portion.

10. The internal combustion engine as recited in claim 8, wherein the first bore portion of the bore is formed by reaming.

11. The internal combustion engine as recited in claim 8, wherein the generally annular collar of the shank portion is formed by one of precision forming and grinding.

12. The internal combustion engine as recited in claim 8, wherein the main bearing cap is formed integrally with the bulkhead and is subsequently separated from the bulkhead by a fracturing process such that a fracture line is defined by a mounting surface on the bulkhead and a mounting surface on the main bearing cap, the fracture line intersecting the first bore portion.

13. The internal combustion engine as recited in claim 8, wherein the clearance between the generally annular collar and the first bore portion is between 0.02 mm and 0.20 mm.

14. The internal combustion engine as recited in claim 8, wherein the bulkhead and the main bearing cap are formed from compacted graphite iron.

15. A method of aligning a main bearing support structure for an internal combustion engine comprising the steps of:
providing the main bearing support structure, wherein the main bearing support structure includes a bulkhead portion and at least one main bearing cap;
providing at least one bore through the at least one main bearing cap and extending into the bulkhead portion, wherein the at least one bore includes a first portion and a threaded portion;
providing a threaded fastener for each of the at least one bores, wherein the threaded fastener includes a shank portion, an annular collar portion and a threaded fastener portion; and
installing the threaded fastener into each of the at least one bores to assemble the at least one main bearing cap to the bulkhead portion, such that the annular collar portion of the threaded fastener is sufficiently tightly fitted within the at least one bore to align each of the at least one main bearing cap with the bulkhead portion.

16. The method of claim 15, wherein the at least one main bearing cap is formed integrally with the bulkhead portion and further including the steps of:
separating the at least one main bearing cap from the bulkhead portion; and
reassembling the at least one main bearing cap to the bulkhead portion.

17. The method of claim 16, wherein the at least one main bearing cap is separated from the bulkhead portion by a fracturing operation.

18. The method of claim 15, wherein the bulkhead portion includes the threaded portion and wherein the bulkhead portion and the at least one main bearing cap cooperate to form the first portion.

19. The method of claim 18, wherein the first portion is formed by reaming.

20. The method of claim 19, wherein the annular collar portion of the threaded fastener is formed by one of precision forming and precision grinding.
